(19) United States
(12) Patent Application Publication
(10) Pub. No.: US 2017/0364846 A1
(43) Pub. Date: Dec. 21, 2017

(54) METHOD AND SYSTEM FOR FACILITATING EXECUTION OF A HUMAN RESOURCE WORKFLOW

(71) Applicant: Robert Jeffrey McConnell, Rolling Hills Estates, CA (US)

(72) Inventor: Robert Jeffrey McConnell, Rolling Hills Estates, CA (US)

(21) Appl. No.: 15/627,233

(22) Filed: Jun. 19, 2017

Related U.S. Application Data
(60) Provisional application No. 62/351,417, filed on Jun. 17, 2016.

(51) Int. Cl. G06Q 10/06; G06Q 10/10

(52) U.S. Cl. CPC G06Q 10/0633; G06Q 10/105

(57) ABSTRACT

Disclosed is a system for facilitating execution of a Human Resource (HR) workflow at a facility. The system may include at least one presentation device, at least one input device, at least one camera, at least one facility sensor and at least one actuator configured to provide physical access to at least one region. Further, the system may include at least one dispenser configured to dispense at least one item to the individual. Further, the system may include at least one processing device in communication with the at least one facility sensor, the at least one actuator and the at least one dispenser. Further, the at least one processing device may be configured to control operation of the at least one actuator and the at least one dispenser. Further, the system may include at least one communication device configured to perform communication with a remote station.

The current application claims a priority to the U.S. Provisional Patent application Ser. No. 62/351,417 filed on Jun. 17, 2016. The current application is filed on Jun. 19, 2017, whereas Jun. 17, 2017 and Jun. 18, 2017 were on a weekend.

### FIELD OF THE INVENTION

The present invention relates generally to the field of communication technology. More specifically, the present invention relates to methods and systems for facilitating execution of a Human Resource Workflow.

### BACKGROUND OF THE INVENTION

With the advancement of technology, a greater number of tasks that were traditionally performed by humans are now being performed, at least in part, by computers. As a result, humans are freed, at least partially, from the burden of performing these tasks. However, there are some areas of human endeavor that continue to be largely dependent on human involvement, such as conducting a recruitment camp, an on-boarding process and/or an orientation program for employees, etc.

For instance, the recruitment process is typically conducted by inviting candidates to a predetermined facility (such as an office) and conducting interviews and/or various other forms of assessment. Further, the entire recruitment process is generally monitored and controlled by recruiting staff. For example, upon completion of one stage of the recruitment process, the recruiting staff may escort a candidate to another secured area for another stage of the recruitment process. Alternatively, the recruiting staff may be provided access control cards with specific access rights assigned manually by the recruitment staff and guide the candidate through various stages of the recruitment process. Similarly, in a process of on-boarding new employees, one or more staff of the company may be involved in interacting with a new employee in performing various stages, such as provisioning of ID card, access card, etc.

As is evident, there are several problems with existing methods and systems for executing Human Resource (HR) workflows, such as recruitment and/or on-boarding of employees. Firstly, companies are forced to invest in resources to conduct HR workflows that may occur infrequently. For example, a company may conduct a recruitment drive once in six months or on a need basis. Accordingly, the resources purchased for specifically conducting the recruitment drive may either be unused in other times and/or difficult and burdensome to re-deploy for another use in the company. Secondly, requiring candidates to be physically present at the company premises places severe constraints on the talent pool. Accordingly, companies may not be able to consider recruiting individuals located far from the company premises. Thirdly, existing methods of conducing HR workflows involves extensive participation of staff members leading to burden on users, increased likelihood of errors and inefficiencies.

Accordingly, there is a need for methods and systems for facilitating execution of HR workflows that can overcome one or more of, but not limited to, the above mentioned drawbacks.

### SUMMARY

This summary is provided to introduce a selection of concepts in a simplified form that are further described below in the Detailed Description. This summary is not intended to identify key features or essential features of the claimed subject matter. Nor is this summary intended to be used to limit the claimed subject matter's scope.

In accordance with some embodiments, the present disclosure provides a system for facilitating execution of a Human Resource (HR) workflow at a facility. The system may include at least one presentation device configured to present presentation data associated with the HR workflow to an individual. Further, the system may include at least one input device configured to receive receivable data associated with the HR workflow from the individual. Further, the system may include at least one camera configured to capture an image of the individual. Further, the system may include at least one facility sensor configured to sense at least one interaction of the individual with the facility. Further, the system may include at least one actuator configured to provide physical access to at least one region of the facility. Further, the physical access may be provided to the individual based on the HR workflow. Further, the system may include at least one dispenser configured to dispense at least one item associated with the HR workflow to the individual. Further, the at least one item may be dispensed to the individual based on the HR workflow. Further, the system may include at least one processing device in communication with the at least one facility sensor, the at least one actuator and the at least one dispenser. Further, the at least one processing device may be configured to control operation of the at least one actuator and the at least one dispenser. Further, the system may include an at least one communication device coupled to the at least one processing device. Further, the at least one communication device may be configured to perform communication with a remote station. Further, the communication may include the presentation data, the receivable data, and the image of the individual.

In accordance with some embodiments, the present disclosure provides a method for facilitating execution of a Human Resource (HR) workflow at a facility. The method may include presenting, using at least one presentation device, presentation data associated with the HR workflow to an individual. Further, the method may include receiving, using at least one input device, receivable data associated with the HR workflow from the individual. Further, the method may include capturing, using at least one camera, an image of the individual. Further, the method may include sensing, using at least one facility sensor, at least one interaction of the individual with the facility. Further, the method may include providing, using at least one actuator, physical access to at least one region of the facility. Further, the physical access may be provided to the individual based on the HR workflow. Further, the method may include dispensing, using at least one dispenser, at least one item associated with the HR workflow to the individual. Further, the at least one item may be dispensed to the individual based on the HR workflow. Further, the method may include controlling, using at least one processing device, operation of the at least one actuator and the at least one dispenser. Further, the at least one processing device may be in communication with the at least one facility sensor, the at least one actuator and the at least one dispenser. Further, the method may include performing a communication, using at least one communication device coupled to the at least one processing device, with a remote station. Further, the communication may include the presentation data, the receivable data, the image of the individual.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of a platform consistent with various embodiments of the present disclosure.

FIG. 2 is an illustration of a system for facilitating execution of a HR workflow in conjunction with a remote station, in accordance with some embodiments.

FIG. 3 is an illustration of a system for facilitating execution of a HR workflow in a facility, in accordance with an exemplary embodiment.

FIG. 4 is an illustration of an architecture of the system for facilitating execution of a HR workflow in conjunction with a remote station, in accordance with some embodiments.

FIG. 5 is a flowchart of a method of facilitating execution of a HR workflow in conjunction with a remote station, in accordance with some embodiments.

FIG. 6 is a block diagram of a computing device (also referred to herein as a processing device) for implementing the methods disclosed herein, in accordance with some embodiments.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in, the context of HR workflows such as recruitment and/or onboarding of employees, embodiments of the present disclosure are not limited to use only in this context.

Overview

Consistent with embodiments of the present disclosure, an online platform (also referred to herein as “platform” or HR workflow platform) for facilitating execution of a Human Resource (HR) workflow, such as, for example, recruitment, on-boarding etc. may be provided. This overview is provided to introduce a selection of concepts in a simplified form that are further described below. This overview is not intended to identify key features or essential features of the claimed subject matter. Nor is this overview intended to be used to limit the claimed subject matter's scope. The online platform may be used by individuals or companies to facilitate execution of a HR workflows.

According to some embodiments, the present disclosure eliminates the need to manage human capital in staffing offices throughout multiple markets. The present disclosure may be a computer-related process of removing human beings from a staffing, recruitment and/or employment on-boarding office. These unattended professional offices may be supported through internet connectivity to real time digital renderings of offsite personnel. Unattended staffing offices may still offer one on one service digitally but there may be no professional attending the office.

Candidates visiting the unattended staffing office have the ability to fill out forms on line or on paper, sign pre-employment forms, photograph personal identification, take drug tests and authorize any other pre-employment forms or processes.

In its preferred embodiment, the present disclosure may be referred to hereinafter as, “Unattended Staffing, Recruitment and/or Employment On-Boarding Office.” The office without humans can also stay open 24 hours a day 7 days a week. Managing contact/recruitment centers instead of individual offices guarantees all applicants continuity in the interviewing and on-boarding experience. The cost of offering localized service is greatly reduced when you digitally dispatch all walk-ins to centralized offices. The unattended staffing office eliminates the local cost of human capital without impacting the employment process, extends servicing hours and offers staffing companies more affordable access to near site offices by client locations.

The process for the present disclosure may include the connection of unattended staffing office digitally to recruitment hubs. The unattended staffing office may have motion detectors, cameras and monitors to connect candidates and recruiters with visual and audio connection. The recruiter may digitally instruct the candidate through all other processes that are enabled by video cameras, voice recorders, printers, cameras and a safe to deposit signed forms and/or completed drug tests.

According to an exemplary embodiment, the present disclosure provides a system (also referred to herein as Agile Force™) includes an unmanned staffing/recruitment process utilizing two technologies. One targets the candidate/employee, AgileForceID (AFID), and the other targets the Employer, Virtual Office Site (VOS).

The Virtual Office Site may be a small unmanned office, ˜500 sq ft., equipped with technology that may allow remote staffing employees to interact with candidates and monitor them as they go through the automated onboarding process. Utilizing door & presence awareness devices, 2-way video, scanning technology, computer workstations, remote drug testing equipment and internet of things (IoT) enabled dispensing equipment, the employer can handle all the onboard steps without being in the remote location, even dispensing an employee badge and sending them directly to the location in need.

The AFVOS may provide the following features:
Greeting station—This is the main video station through which the employee may interact with remote onboarding staffers. It may have a large 50″ HD screen, HD camera, high density microphone & speakers, and connect to imbedded computer that may run the AFVOS greeting application.
Computer Workstation—There may be 1 to many workstations with a typical deployment targeted for 2-4. These stations may have touch screen technology, 2 way video communication capabilities for human interaction, card readers, and AFVOS onboarding processing application. Each station may be enclosed in a walled cubicle allow the IoT enabled cameras to follow them but to also provide privacy from others who may be in the facility at the same time. Facial recognition software may be utilized to authenticate returning candidates.
Agent Station—The remote agents may have an application that functions like a call center. They may login and be configured to support 1 to many AFVOS'. Agents may have the ability to:
   See and be alerted of activity in the AFVOS.
   Monitor, via video feeds, people in the facility.
   See what stage the employee may be at in the onboarding process in each workstation.
   If invited by the employee, move to a screen sharing session to aid the employee in any difficulties they might encounter.
   Monitor the stock levels of supplies in the IoT enabled dispensing machines (iDM), if present.
   Monitor the status/stock levels of badging materials in the badging machine (iBM).
   Manually trigger the iDM to release a product if necessary
   Manually trigger the iBM to reprint a badge
   Manually release the foyer door lock to allow entrance after hours if the AFVOS may be to be open 24 hours.
   They can also control all environmental aspects of the AFVOS, like security locks, lighting, power, HVAC systems, and trigger remote alarms if needed.

AFID: Today prospective employees must provide proof of ability to work and in many cases, pass a drug test. If they are applying for a skilled position, like tree-top forklift operator, they may also need to provide proof of certification. This information may be provided every time an employee changes jobs. They have no place to digitally store this information for reuse. The information may be stored by the employer or staffing agent in their workforce management (WFM) system but it may be not provided to the employee. The AFID may be the employee's unique ID that may be transferable to all WFM systems that can store and provide the necessary digital documents for employment through a controlled, secure and automated fashion. Further, the system may also provide a certification process and network for all employers utilizing the AFID to provide a measure of credibility of the candidate's documents and work history who have a certified AFID.

AFID Features:
Digital vault—Ability to store various identification documents that may be coded with an industry standard system code to allow other systems to automatically recognize the type of document. Agile Force may provide this standard system, as open source, to the industry to facilitate a common language of document sharing.
Security—Given the level of Personal Identification Information the system may house, it may be required to setup 2 factor authentication. This may insure that only the employee may be able to control the movement of information to and from the system.
Certification—Documents stored with the AFID during the onboarding process may be verified by the agent and may receive a 3^{rd} party digital certification. This digital cert may be issued utilizing block chain technology to establish a triple ledger system that may allow future employers to verify that documents sent to them are legitimate.

Platform Configuration

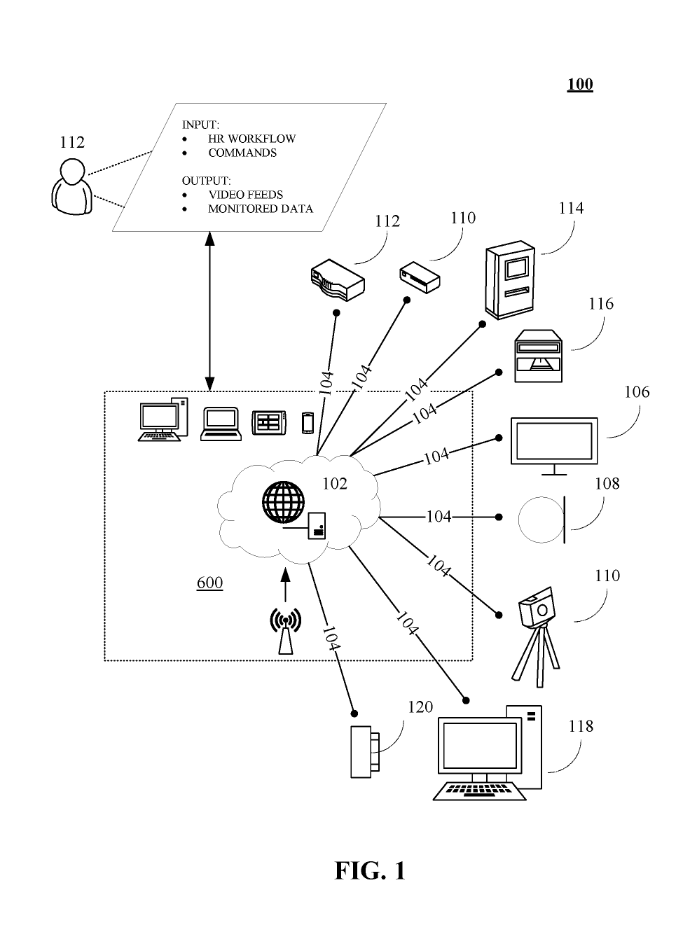

FIG. 1 is an illustration of an online platform 100 consistent with various embodiments of the present disclosure. By way of non-limiting example, the online platform 100 for facilitating execution of HR workflows may be hosted on a centralized server 102, such as, for example, a cloud computing service. The centralized server 102 may communicate with other network entities, such as, for example, a presentation device 106, an input device 108 (such as a microphone), a camera 110, a facility sensor 112 such as a proximity sensor), an actuator (such as electromagnetic door lock), a dispenser 114 (such as a badge/access-card dispenser), a biological analyzer 116, a workstation 118 and room automation unit 120 over a communication network 104, such as, but not limited to, the Internet. In addition, in some embodiments, the platform may also be in communication with a physical testing device, a simulator and biometric readers. Further, users of the platform may include relevant parties such as one or more of job seekers, employees, interns, students, recruiters, company staff, sports person, coaches, sports managers and so on. Accordingly, electronic devices operated by the one or more relevant parties may be in communication with the platform.

A user 112, such as the one or more relevant parties, may access platform 100 through a software application. The software application may be embodied as, for example, but not be limited to, a website, a web application, a desktop application, and a mobile application compatible with a computing device 600.

Accordingly, in an instance, the user 112 may access the platform in order to facilitate execution of a HR workflow, such as, for example, recruitment. The user 112 may accordingly provide a recruitment workflow that specifies one or more processes, one or more rules specifying conditions and corresponding actions to be performed based on occurrence of the conditions, etc. Accordingly, the platform may be configured to facilitate execution of the recruitment workflow by interacting with one or more components of the system (such as those illustrated in FIG. 1).

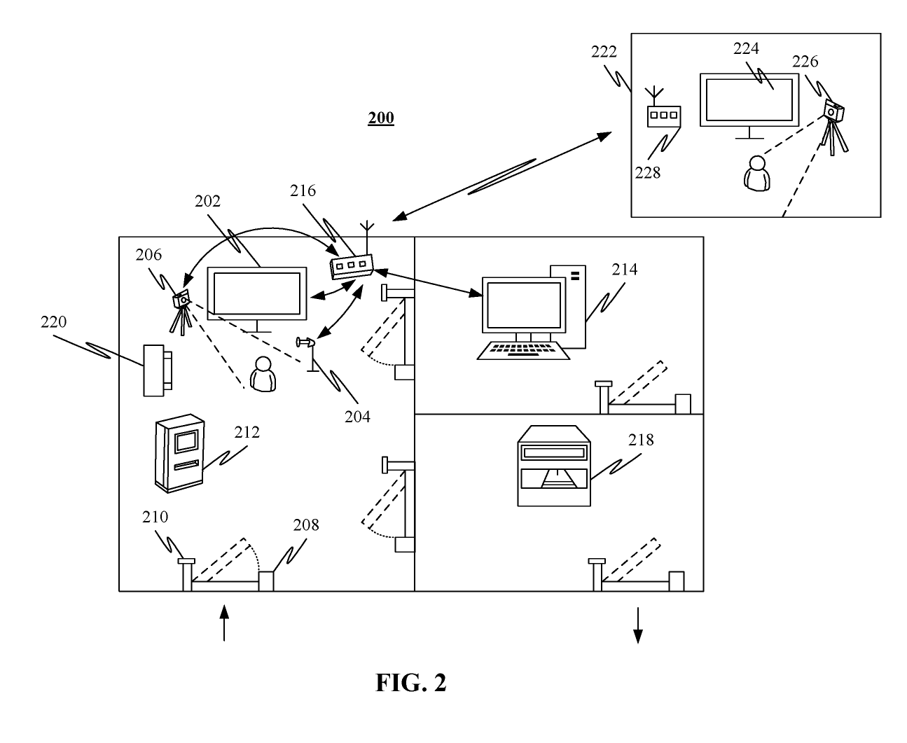

FIG. 2 is an illustration of a system 200 for facilitating execution of a HR workflow in conjunction with a remote station, in accordance with some embodiments. The system 200 may include at least one presentation device 202 configured to present presentation data associated with the HR workflow to an individual. Further, the system 200 may include at least one input device 204 configured to receive receivable data associated with the HR workflow from the individual. Further, the system 200 may include at least one camera 206 configured to capture an image of the individual. Further, the system 200 may include at least one facility sensor 208 configured to sense at least one interaction of the individual with the facility. Further, the system 200 may include at least one actuator 210 configured to provide physical access to at least one region of the facility. Further, the physical access may be provided to the individual based on the HR workflow. Further, the system 200 may include at least one dispenser 212 configured to dispense at least one item associated with the HR workflow to the individual. Further, the at least one item may be dispensed to the individual based on the HR workflow. Further, the system 200 may include at least one processing device 214 in communication with the at least one facility sensor 208, the at least one actuator 210 and the at least one dispenser 212. Further, the at least one processing device 214 may be configured to control operation of the at least one actuator 210 and the at least one dispenser 212. Further, the system 200 may include and at least one communication device 216 coupled to the at least one processing device 214. Further, the at least one communication device may be configured to perform communication with a remote station. Further, the communication may include the presentation data, the receivable data, the image of the individual.

In addition, in some embodiments, the system 200 may include a biological analyzer 218 configured to perform biological analysis of a sample of biological derived from the individual. The biological sample may include, for example, but is not limited to, a blood sample, a saliva sample, a buccal swab sample, a urine sample, a stool sample, a hair sample, a skin sample and so on. Accordingly, the biological analysis may include determination of one or more substances, such as for example, blood constituents, DNA, drugs and so on.

In some embodiments, the at least one biological analyzer 218 may be configured to detect presence of at least one chemical substance in a predefined range of concentration. For instance, the at least one chemical substance may be a restricted substance such as alcohol, tobacco, cocaine, heroin, methamphetamine, ketamine, LSD, marijuana, hallucinogens, steroids, MDMA, prescription drugs and so on. Further, the HR workflow may include an indication of the at least one chemical substance. For example, the HR workflow may indicate a requirement of traces of controlled substances (alcohol, addictive drugs etc.) to be absent in the biological sample of the individual in order to meet eligibility for a job (e.g. forklift operator).

Further, in some embodiments, the system 200 may include a room automation unit 220 configured to control at least one environmental variable associated with the facility.

Further, the system 200 may include a remote station 222 comprising a remote presentation device 224, a remote camera 226 and a remote communication device 228. The remote station 222 may be manned by, for example, an administrator of the HR workflow.

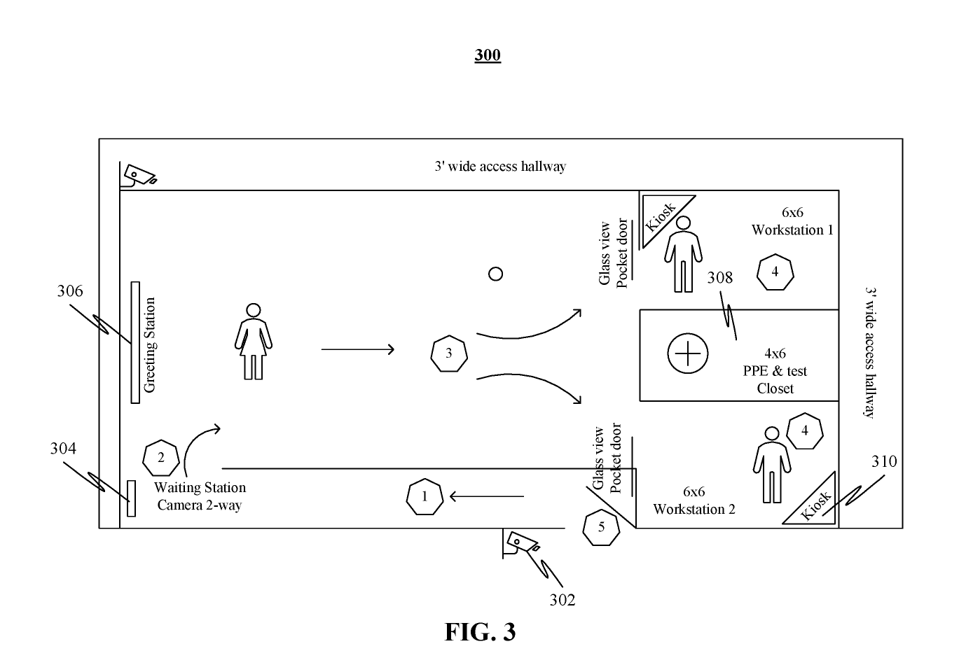

FIG. 3 is an illustration of flow diagram of a method 300 for facilitating execution of a HR workflow in a facility, in accordance with an exemplary embodiment. At step 1, a candidate may enter a queuing hallway. At step 2, the candidate may be placed in the waiting area which may include a 2-way camera for communicating with a security person. Further, the waiting area may lead to a second doorway which opens to a greeting area where the hiring process may start. The greeting area may accordingly include a greeting station for displaying greeting information. At step 3, the candidate may be directed to a workstation (e.g. workstation 1 or 2). At the workstation, the candidate may login and provide eligibility. Subsequently, an interview process may be conducted at the workstation and if successful, the candidate may be directed to proceed to the drug screening. Accordingly, access to a drug kit closet may be granted. While performing the drug test, for example, by taking a swab sample, the candidate may be in view of a camera. Additionally, RFID of test may also be scanned. Subsequently, safety onboarding video may be presented to the candidate. At step 5, an introduction video session may be initiated with hiring/supervising manager. At step 6, the candidate may be asked for final questions and dismissed. At step 7, if the candidate passes the drug test, access to the Personal Protection Equipment (PPE) may be granted to the candidate. Subsequently, at step 8, PPE may read RFID tags and at step 9, the onboarding may be completed.

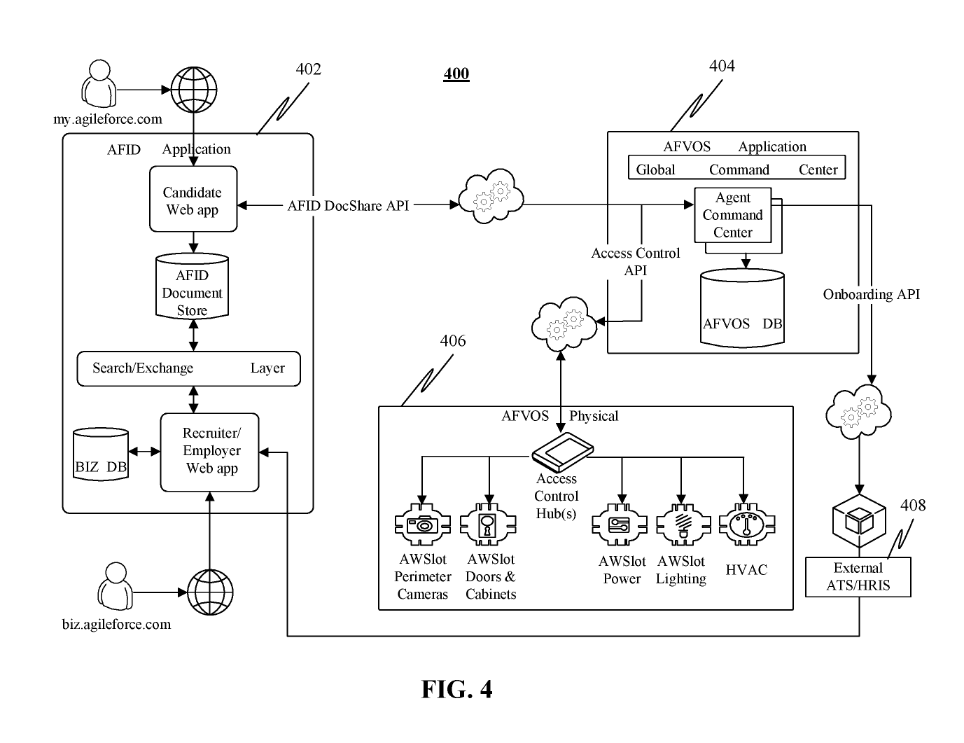

FIG. 4 is an illustration of an architecture of the system 400 for facilitating execution of a HR workflow in conjunction with a remote station, in accordance with some embodiments. As illustrated, the system 400 may include the AFID application component 402, AFVOS Application component 404 and AFVOS Physical component 406 interconnected to each other through a communication network. Additionally, the system 400 may include an external Applicant Tracking System (ATS)/Human Resource Information System (HRIS) 408 in communication with the AFID application component 402.

The AFID application component 402 may include a candidate web app, an AFID Document store, a search/exchange layer, a recruiter/employer web app and a business database. Further, the AFVOS application component 404 may include a global command center, an agent command center and an AFVOS database. Furthermore, the AFVOS physical component 406 may include an access control hub in communication with Agile Workstation (AWSlot) Perimeter cameras, AWSlot Doors and Cabinets, AWSlot Power, AWSlot Lighting and HVAC components.

Platform Operation

Although method 500 has been described to be performed by platform 100, it should be understood that computing device 600 may be used to perform the various stages of method 500. Furthermore, in some embodiments, different operations may be performed by different networked elements in operative communication with computing device 600. For example, a server may be employed in the performance of some or all of the stages in method 500. Moreover, the server may be configured much like computing device 600.

Although the stages illustrated by the flow charts are disclosed in a particular order, it should be understood that the order is disclosed for illustrative purposes only. Stages may be combined, separated, reordered, and various intermediary stages may exist. Accordingly, it should be understood that the various stages illustrated within the flow chart may be, in various embodiments, performed in arrangements that differ from the ones illustrated. Moreover, various stages may be added or removed from the flow charts without altering or deterring from the fundamental scope of the depicted methods and systems disclosed herein. Ways to implement the stages of the method 500 will be described in greater detail below.

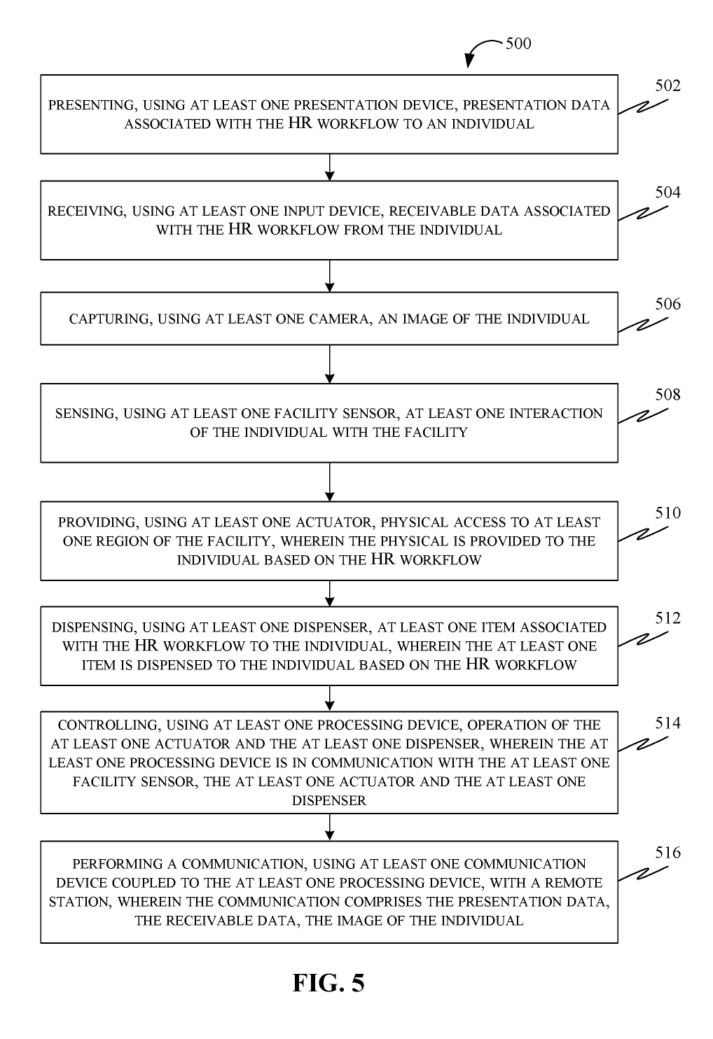

FIG. 5 is a flowchart of a method 500 of facilitating execution of a HR workflow in conjunction with a remote station, in accordance with some embodiments. The HR workflow may generally include any predefined process involving one or more human resources. Examples of HR workflows include, but are not limited to, a recruitment process (for job, sports, adventure camps, etc.), on-boarding process, orientation process, training process, performing a job role, etc.

In an instance where the HR workflow corresponds to a recruitment process, as a result of executing the recruitment process, one or more individuals may be subjected to one or more assessments to evaluate suitability of the one or more individuals for one or more job roles. Accordingly, the HR workflow process may include filling of one or more forms (hardcopy and/or electronic forms), one or more interviews, one or more written assessments, one or more physical tests, one or more cognitive tests, one or more psychological tests, one or more emotional tests etc.

Although the invention is described in the context of HR workflows such as recruitment and on-boarding. The invention may be understood to be applicable in other processes involving human resources. For example, the HR workflow may define performance of a job role by an individual involving for example, interaction with one or more equipment located in restricted areas. Accordingly, a time of access, a level of access etc. may be automatically controlled by the invention in order to enable the individual to perform the job role on a daily basis.

The facility in general may include any physical infrastructure that provides for installation of the components of the system (i.e. the at least one presentation device, the at least one input device, the at least one facility sensor, the at least one actuator, the at least one actuator and the at least one communication device). In an instance, the facility may include a plurality of rooms conforming to a predefined layout. In another instance, the facility may include a collapsible structure that is configured to create the at least one region upon installation. Accordingly, the facility may be erected on a need basis, such as for example on campus ground for conducting a recruitment drive. Accordingly, the collapsible structure may include mounting mechanisms configured to mount one or more of the components of the system. Consequently, a portable facility may be provided that may be conveniently transported to a target location, erected, and then uninstalled after use.

The method 500 may include a stage 502 of presenting, using at least one presentation device, presentation data associated with the HR workflow to an individual. The at least one presentation device in general may include any device capable of presenting information to the individual. Accordingly, the at least one presentation device may correspond to one or more sensory modalities of individuals, such as, sight, hearing, touch, smell and taste. For instance, the at least one presentation device may include one or more display devices, holographic devices, one or more sound generating devices (i.e. speakers), braille displays, and so on.

Further, the method 500 may include a stage 504 of receiving, using at least one input device, receivable data associated with the HR workflow from the individual. The at least one input device in general may include any device capable of receiving an input from the individual. In an instance, the input device may be a touch-screen which may also be configured to function as the at least one presentation device. In other words, in an embodiment, the at least one presentation device and the at least one input device may be integrated in a single device (i.e. touchscreen). Other examples of input device include, but are not limited to, keyboard, microphone, mouse, stylus, etc.

Further, the method 500 may include a stage 506 of capturing, using at least one camera, an image of the individual. The at least one camera in general may be configured to capture an image of the individual and/or image of at least one region of the facility. Accordingly, the at least one camera in some embodiments, may include surveillance cameras with a wide field of view suitable for monitoring a region of the facility. In other embodiments, the at least one camera may include an HD camera configured to capture a high quality image of the individual from a close distance in order to provide a richer telepresence experience to individuals located at the remote station. Additionally, in some embodiments, the at least one camera may also be configured for capturing images of paper documents, ID cards, badges, etc. Accordingly, the at least one camera may be capable of capturing light of a wide range of frequencies including, but not limited to, visible light, near-IR, IR light and UV light.

Further, the method 500 may include a stage 508 of sensing, using at least one facility sensor, at least one interaction of the individual with the facility. In general, the at least one facility sensor may include any sensor capable of sensing at least one state of a component comprised in the facility. Further, the at least one state of the component may be alterable based on an interaction of the individual with the component. Accordingly, the at least one sensor may capture at least one interaction of the individual with the facility (i.e. one or more components of the facility). For example, the at least one sensor may include proximity sensors installed at one or more predefined locations in the facility. Further, the one or more proximity sensors may be configured to detect presence of the individual at the one or more predefined locations. Additionally, in some embodiments, the at least one sensor may be associated with one or more doors. Further, the at least one sensor may be configured to detect a state (i.e. open, closed) of the one or more doors.

Further, the method 500 may include a stage 510 of providing, using at least one actuator, physical access to at least one region of the facility. Further, the physical access may be provided to the individual based on the HR workflow. In general, the at least one actuator may correspond to one or more restricted regions in the facility. For instance, the at least one actuator may be configured to control a state of a door leading to a restricted region. Accordingly, activating the at least one actuator may change the state of the door from a closed state to an opened state. As a result, the individual may be allowed to enter the restricted region. The at least one actuator in some embodiments may be activated based on receipt of a PIN number. Accordingly, the at least one actuator may be coupled with a keypad configured for receiving the PIN number. In other embodiments, the at least one actuator may be coupled to an RFID reader configured to read RFID tags. Accordingly, the individual carrying an authorized RFID tag present near the RFID reader may automatically trigger activation of the at least one actuator. In some embodiments, the at least one actuator may be coupled to a magnetic stripe card reader configured to read magnetic stripe cards. Accordingly, the individual may activate the at least one actuator by swiping the magnetic stripe card. In some other embodiments, the at least one actuator may be coupled to a biometric reader configured to capture a biometric feature of the individual (e.g. fingerprint, iris pattern, palm print, facial features, voice features, etc.). Further, the biometric reader may be able to identify the individual based on the biometric feature and activate the at least one actuator accordingly.

In some embodiments, the at least one actuator may be further configured to be remotely controlled. Accordingly, the at least one actuator may be coupled to a communication device capable of receiving a command from the remote station. For example, an administrator of the HR workflow may issue one or more commands to the at least one actuator at various times in order to remotely control the state of one or more doors in the facility according to the stage of the HR workflow (e.g. interview stage, physical test stage, drug test stage, etc.).

Further, the method 500 may include a stage 512 of dispensing, using at least one dispenser, at least one item associated with the HR workflow to the individual. Further, the at least one item may be dispensed to the individual based on the HR workflow. In general, the at least one dispenser may be any device capable of supplying one or more items associated with the HR workflow to the individual. In some embodiments, the at least one dispenser may be configured to dispense RFID badges/tags based on information associated with the individual. Accordingly, the RFID badge/tag may enable the individual to obtain access to one or more restricted regions in the facility based on the RFID badge/tag. In another embodiment, the at least one dispenser may be configured for dispensing magnetic stripe cards.

Further, the method 500 may include a stage 514 of controlling, using at least one processing device, operation of the at least one actuator and the at least one dispenser. Further, the at least one processing device may be in communication with the at least one facility sensor, the at least one actuator and the at least one dispenser. Further, the method 500 may include a stage 516 of performing a communication, using at least one communication device coupled to the at least one processing device, with a remote station. Further, the communication may include the presentation data, the receivable data, the image of the individual.

In some embodiments, the method 500 may further include a stage of performing, using at least one biological analyzer, biological analysis of a biological sample derived from the individual. The biological sample may include, for example, but is not limited to, a blood sample, a saliva sample, a buccal swab sample, a urine sample, a stool sample, a hair sample, a skin sample and so on. Accordingly, the biological analysis may include determination of one or more substances, such as for example, blood constituents, DNA, drugs and so on. Additionally, the method 500 may include a stage of communicating a result of the biological analysis to the at least one processing device.

In some embodiments, the at least one biological analyzer may be configured to detect presence of at least one chemical substance in a predefined range of concentration. For instance, the at least one chemical substance may be a restricted substance such as alcohol, tobacco, cocaine, heroin, methamphetamine, ketamine, LSD, marijuana, hallucinogens, steroids, MDMA, prescription drugs and so on. Further, the HR workflow may include an indication of the at least one chemical substance. For example, the HR workflow may indicate a requirement of traces of controlled substances (alcohol, addictive drugs etc.) to be absent in the biological sample of the individual in order to meet eligibility for a job (e.g. forklift operator).

In some embodiments, the method 500 may further include a stage of performing, using at least one physical testing device, a physical assessment of at least one physical ability of the individual. Additionally, the method 500 may include a stage of communicating a result of the physical assessment to the at least one processing device. The at least one physical testing device, in general, may include any device capable of facilitating assessment of at least one physical ability of the individual. The at least one physical ability may include, but is not limited to, strength, stamina, skill, dexterity and so on. In some embodiments, the at least one physical testing device may be configured to assess a physical activity indicated in the HR workflow. Examples of the at least one physical testing device may include, but are not limited to, a treadmill, an exercise bike, weight lifting machine, etc.

In some embodiments, the method 500 may further include a stage of performing, using at least one simulator, a simulation at least one environment associated with the HR workflow. In general, the at least one simulator may be any device capable of simulating one or more of physical and mental activity. In some embodiments, the at least one simulator may include equipment that mimics working of a machine associated with the HR workflow. For instance, the HR workflow may be corresponding to a recruitment process for forklift operators. Accordingly, the at least one simulator may simulate the operation of a forklift in order to evaluate operational skills of the individual.

Accordingly, the method 500 may include a stage of capturing, using the at least one simulator, an interaction of the individual with the at least one simulator. Further, the method 500 may include a stage of generating, using the at least one simulator, a result of the simulation based on the interaction. Furthermore, the method 500 may include a stage of communicating, using the at least one simulator, the result of the simulation to the at least one processing device.

In some embodiments, the method 500 may further include a stage of scanning, using at least one scanner, at least one physical document associated with the individual. The at least one physical document may include, for example, but is not limited to, an ID card, certificate, etc. Additionally, the method 500 may include a stage of communicating, using the at least one scanner, at least one electronic document corresponding to the at least one physical document to the at least one processing device.

In some embodiments, the method 500 may further include a stage of securely storing, using a digital vault, at least one electronic document associated with the individual. Electronic versions of documents relevant to the HR workflow may be retrieved from the digital vault. The digital vault is a secured storage server employing block chain techniques to store the at least one electronic document. Accordingly, authenticity and integrity of the at least one electronic document may be maintained. Additionally, the method 500 may include a stage of communicating, using the digital vault, the at least one electronic document to the at least one processing device.

In some embodiments, the method 500 may further include a stage of detecting, using the at least one dispenser, a quantity of the one or more items available for dispensing. Additionally, the method 500 may include a stage of communicating, using the at least one dispenser, the quantity to the at least one processing device. Further, the method 500 may include a stage of generating, using the at least one processing device, an inventory alert based on the quantity being less than a predetermined amount. Furthermore, the method 500 may include a stage of transmitting, using the at least one communication device, the inventory alert to the remote station.

In some embodiments, the method 500 may further include a stage of controlling, using a room automation unit, at least one environmental variable associated with the facility. The room automation unit may be connected to one or more environmental sensors and one or more environmental modifier devices (e.g. heaters, coolers, air-conditioners, humidifiers, filters, fans, lights, etc.). Additionally, the method 500 may include a stage of communicating, using the room automation unit, with the at least one processing device.

In some embodiments, the method 500 may further include a stage of capturing, using at least one biometric reader, at least one biometric feature associated with the individual. The at least one biometric reader may include for example, but not limited to, fingerprint, iris pattern, palm print, facial features, voice features, etc. Additionally, the method 500 may include a stage of communicating, using the at least one biometric reader, the at least one biometric feature to the at least one processing device.

Platform Architecture

The platform 100 may be embodied as, for example, but not be limited to, a website, a web application, a desktop application, and a mobile application compatible with a computing device. The computing device may comprise, but not be limited to, a desktop computer, laptop, a tablet, or mobile telecommunications device. Moreover, the platform 100 may be hosted on a centralized server, such as, for example, a cloud computing service. Although method 500 has been described to be performed by a computing device 600, it should be understood that, in some embodiments, different operations may be performed by different networked elements in operative communication with computing device 600.

Embodiments of the present disclosure may comprise a system having a memory storage and a processing unit. The processing unit coupled to the memory storage, wherein the processing unit is configured to perform the stages of method 500.

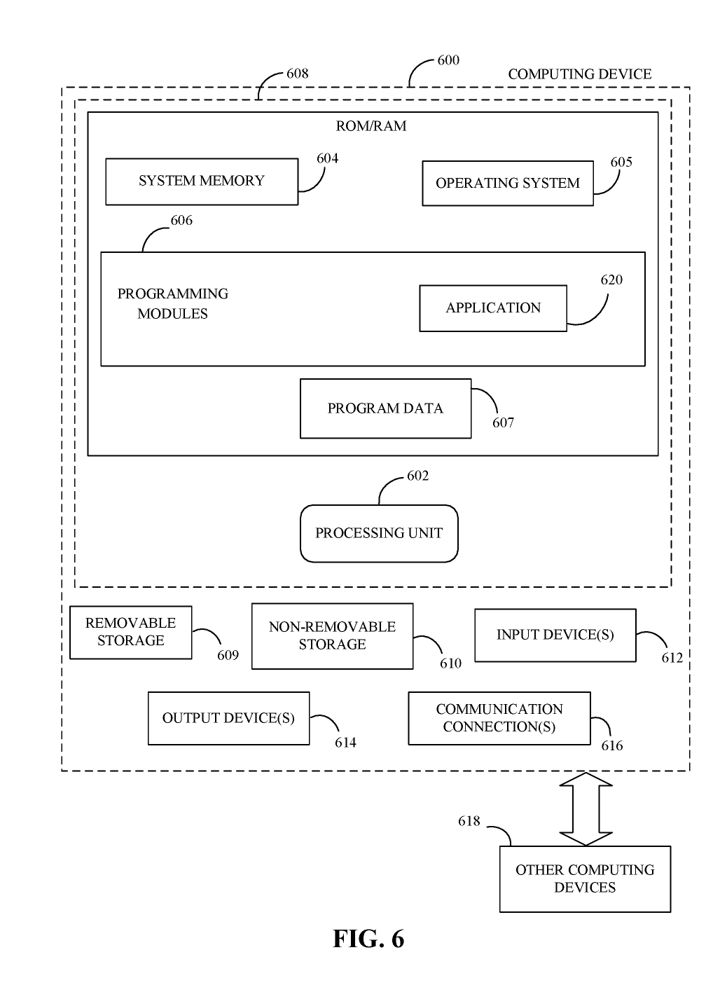

FIG. 6 is a block diagram of a system including computing device 600. Consistent with an embodiment of the disclosure, the aforementioned storage device and processing device may be implemented in a computing device, such as computing device 600 of FIG. 6. Any suitable combination of hardware, software, or firmware may be used to implement the memory storage and processing unit. For example, the storage device and the processing device may be implemented with computing device 600 or any of other computing devices 618, in combination with computing device 600. The aforementioned system, device, and processors are examples and other systems, devices, and processors may comprise the aforementioned storage device and processing device, consistent with embodiments of the disclosure.

With reference to FIG. 6, a system consistent with an embodiment of the disclosure may include a computing device or cloud service, such as computing device 600. In a basic configuration, computing device 600 may include at least one processing unit 602 and a system memory 604. Depending on the configuration and type of computing device, system memory 604 may comprise, but is not limited to, volatile (e.g. random access memory (RAM)), non-volatile (e.g. read-only memory (ROM)), flash memory, or any combination. System memory 604 may include operating system 605, one or more programming modules 606, and may include a program data 607. Operating system 605, for example, may be suitable for controlling computing device 600's operation. In one embodiment, programming modules 606 may include image encoding module, machine learning module and image classifying module. Furthermore, embodiments of the disclosure may be practiced in conjunction with a graphics library, other operating systems, or any other application program and is not limited to any particular application or system. This basic configuration is illustrated in FIG. 6 by those components within a dashed line 608.

Computing device 600 may have additional features or functionality. For example, computing device 600 may also include additional data storage devices (removable and/or non-removable) such as, for example, magnetic disks, optical disks, or tape. Such additional storage is illustrated in FIG. 6 by a removable storage 609 and a non-removable storage 610. Computer storage media may include volatile and nonvolatile, removable and non-removable media implemented in any method or technology for storage of information, such as computer-readable instructions, data structures, program modules, or other data. System memory 604, removable storage 609, and non-removable storage 610 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 600. Any such computer storage media may be part of device 600. Computing device 600 may also have input device(s) 612 such as a keyboard, a mouse, a pen, a sound input device, a touch input device, etc. Output device(s) 614 such as a display, speakers, a printer, etc. may also be included. The aforementioned devices are examples and others may be used.

Computing device 600 may also contain a communication connection 616 that may allow device 600 to communicate with other computing devices 618, such as over a network in a distributed computing environment, for example, an intranet or the Internet. Communication connection 616 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 604, including operating system 605. While executing on processing unit 602, programming modules 606 (e.g., application 620 such as a media player) may perform processes including, for example, one or more stages of methods 300 and 400 as described above. The aforementioned process is an example, and processing unit 602 may perform other processes. Other programming modules that may be used in accordance with embodiments of the present disclosure may include sound encoding/decoding applications, machine learning application, acoustic classifiers etc.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, multiprocessor systems, microprocessor-based or programmable consumer electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

The following is claimed:

1. A system for facilitating execution of a Human Resource (HR) workflow at a facility, the system comprising:
at least one presentation device configured to present presentation data associated with the HR workflow to an individual;
at least one input device configured to receive receivable data associated with the HR workflow from the individual;
at least one camera configured to capture an image of the individual;
at least one facility sensor configured to sense at least one interaction of the individual with the facility;
at least one actuator configured to provide physical access to at least one region of the facility, wherein the physical access is provided to the individual based on the HR workflow;
at least one dispenser configured to dispense at least one item associated with the HR workflow to the individual, wherein the at least one item is dispensed to the individual based on the HR workflow;
at least one processing device in communication with the at least one facility sensor, the at least one actuator and the at least one dispenser, wherein the at least one processing device is configured to control operation of the at least one actuator and the at least one dispenser; and
at least one communication device coupled to the at least one processing device, wherein the at least one communication device is configured to perform communication with a remote station, wherein the communication comprises the presentation data, the receivable data, the image of the individual.

2. The system of claim 1 further comprising at least one biological analyzer configured to perform biological analysis of a biological sample derived from the individual, wherein the biological analyzer is further configured to communicate results of biological analysis to the at least one processing device.

3. The system of claim 2, wherein the at least one biological analyzer is configured to detect presence of at least one chemical substance in a predefined range of concentration, wherein the HR workflow comprises an indication of the at least one chemical substance.

4. The system of claim 1 further comprising at least one physical testing device configured to perform a physical assessment of at least one physical ability of the individual, wherein the wherein the physical testing device is further configured to communicate a result of the physical assessment to the at least one processing device.

5. The system of claim 1 further comprising at least one simulator configured to:
perform a simulation at least one environment associated with the HR workflow;
capture an interaction of the individual with the at least one simulator;
generate a result of the simulation based on the interaction; and
communicate the result of the simulation to the at least one processing device.

6. The system of claim 1 further comprising at least one scanner configured to scan at least one physical document associated with the individual, wherein the at least one scanner is further configured to communicate at least one electronic document associated with the at least one physical document to the at least one processing device.

7. The system of claim 1 further comprising a digital vault configured to securely store at least one electronic document associated with the individual, wherein the digital vault is configured to communicate with the at least one processing device.

8. The system of claim 1, wherein the at least one dispenser is further configured to:
detect a quantity of the one or more items available for dispensing; and
communicate the quantity to the at least one processing device, wherein the at least one processing device is configured to generate an inventory alert based on the quantity being less than a predetermined amount, wherein the at least one communication device is further configured to transmit the inventory alert to the remote station.

9. The system of claim 1 further comprising a room automation unit configured to control at least one environmental variable associated with the facility, wherein the room automation unit is configured to communicate with the at least one processing device.

10. The system of claim 1 further comprising at least one biometric reader configured to capture at least one biometric feature associated with the individual, wherein the at least one biometric reader is further configured to communicate the at least one biometric feature to the at least one processing device.

11. A method for facilitating execution of a Human Resource (HR) workflow at a facility, the method comprising:
presenting, using at least one presentation device, presentation data associated with the HR workflow to an individual;
receiving, using at least one input device, receivable data associated with the HR workflow from the individual;
capturing, using at least one camera, an image of the individual;
sensing, using at least one facility sensor, at least one interaction of the individual with the facility;
providing, using at least one actuator, physical access to at least one region of the facility, wherein the physical access is provided to the individual based on the HR workflow;
dispensing, using at least one dispenser, at least one item associated with the HR workflow to the individual, wherein the at least one item is dispensed to the individual based on the HR workflow;
controlling, using at least one processing device, operation of the at least one actuator and the at least one dispenser, wherein the at least one processing device is in communication with the at least one facility sensor, the at least one actuator and the at least one dispenser; and
performing a communication, using at least one communication device coupled to the at least one processing device, with a remote station, wherein the communication comprises the presentation data, the receivable data, the image of the individual.

12. The method of claim 11 further comprising:
performing, using at least one biological analyzer, biological analysis of a biological sample derived from the individual; and
communicating a result of the biological analysis to the at least one processing device.

13. The method of claim 12, wherein the at least one biological analyzer is configured to detect presence of at least one chemical substance in a predefined range of concentration, wherein the HR workflow comprises an indication of the at least one chemical substance.

14. The method of claim 11 further comprising:
performing, using at least one physical testing device, a physical assessment of at least one physical ability of the individual; and
communicating a result of the physical assessment to the at least one processing device.

15. The method of claim 11 further comprising:
performing, using at least one simulator, a simulation at least one environment associated with the HR workflow;
capturing, using the at least one simulator, an interaction of the individual with the at least one simulator;
generating, using the at least one simulator, a result of the simulation based on the interaction; and
communicating, using the at least one simulator, the result of the simulation to the at least one processing device.

16. The method of claim 11 further comprising:
scanning, using at least one scanner, at least one physical document associated with the individual; and
communicating, using the at least one scanner, at least one electronic document corresponding to the at least one physical document to the at least one processing device.

17. The method of claim 11 further comprising:
securely storing, using a digital vault, at least one electronic document associated with the individual; and
communicating, using the digital vault, the at least one electronic document to the at least one processing device.

18. The method of claim 11 further comprising:
detecting, using the at least one dispenser, a quantity of the one or more items available for dispensing;
communicating, using the at least one dispenser, the quantity to the at least one processing device;
generating, using the at least one processing device, an inventory alert based on the quantity being less than a predetermined amount; and
transmitting, using the at least one communication device, the inventory alert to the remote station.

19. The method of claim 11 further comprising:
controlling, using a room automation unit, at least one environmental variable associated with the facility; and
communicating, using the room automation unit, with the at least one processing device.

20. The method of claim 11 further comprising:
capturing, using at least one biometric reader, at least one biometric feature associated with the individual; and
communicating, using the at least one biometric reader, the at least one biometric feature to the at least one processing device.
